(19) United States
(12) Patent Application Publication
(10) Pub. No.: US 2019/0340846 A1
(43) Pub. Date: Nov. 7, 2019

(54) LOCAL VEHICLE PERFORMANCE EVALUATION

(71) Applicant: Ford Global Technologies, LLC, Dearborn, MI (US)

(72) Inventors: Vijayababu JAYARAMAN, Novi, MI (US); John Naum VANGELOV, South Lyon, MI (US); Brunilda Bleta CAUSHI, Northville, MI (US); Jason Michael MILLER, Woodhaven, MI (US); Mohamad NASSER, Dearborn Heights, MI (US)

(21) Appl. No.: 15/969,379

(22) Filed: May 2, 2018

(51) Int. Cl. G07C 5/08; G06Q 40/08

(52) U.S. Cl. CPC G07C 5/085; G06Q 40/08

(57) ABSTRACT

Systems and methods for evaluating driver performance while maintaining privacy include a vehicle having sensors configured to generate data indicating driving behaviors while the vehicle is being driven. A performance algorithm corresponding to an identifier transmitted from the vehicle to a server is downloaded from the server, and a performance rating calculated by the vehicle by applying the data to the downloaded performance algorithm is displayed by the vehicle. The performance rating and not the data is communicated from the vehicle to the identified server.

### TECHNICAL FIELD

Aspects of the disclosure generally relate to in-vehicle performance evaluation.

### BACKGROUND

The manner in which a driver performs vehicle maneuvers often impacts the driver's ability to maintain control of the vehicle. For example, an overly aggressive driving performance may limit the driver's ability to successfully avoid unexpected road hazards and may cause mechanical damage. Alternatively, a relatively cautious driving performance may lend to improved vehicle control in the face of unexpected road hazards and mechanical longevity.

### SUMMARY

In an exemplary embodiment, a system includes a vehicle having sensors configured to generate data indicating driving behaviors while the vehicle is driven. The vehicle is configured to download, from a server, a performance algorithm corresponding to an identifier transmitted from the vehicle to the server. The vehicle is also configured to display a performance rating calculated by the vehicle by applying the data to the downloaded performance algorithm. The vehicle is further configured to communicate the performance rating and not the data to the server.

In another exemplary embodiment, a system includes a vehicle configured to, responsive to receiving an identifier specific to a particular driver, download a performance algorithm from a server based on the identifier. The vehicle is also configured to, while the vehicle is driven, generate, via vehicle sensors, data indicative of driving behaviors by the driver. The vehicle is further configured to transmit a performance rating calculated by the vehicle by applying the data to the downloaded performance algorithm to the server.

In a further embodiment, a method includes, by a vehicle including sensors configured to generate data indicating driving behaviors while the vehicle is driven, downloading, from a server, a performance algorithm corresponding to an identifier transmitted from the vehicle to the server. The method also includes displaying a performance rating calculated by the vehicle by applying the data to the downloaded performance algorithm. The method further includes transmitting the performance rating and not the data to the server.

### BRIEF DESCRIPTION OF THE DRAWINGS

FIG. 1 is a schematic diagram illustrating an exemplary system for evaluating driver performance while maintaining privacy.

FIG. 2 is a schematic diagram illustrating an exemplary computing platform that may be utilized in the system of FIG. 1.

FIG. 3 is a flowchart illustrating an exemplary process for evaluating driver performance while maintaining privacy that may be performed by system of FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

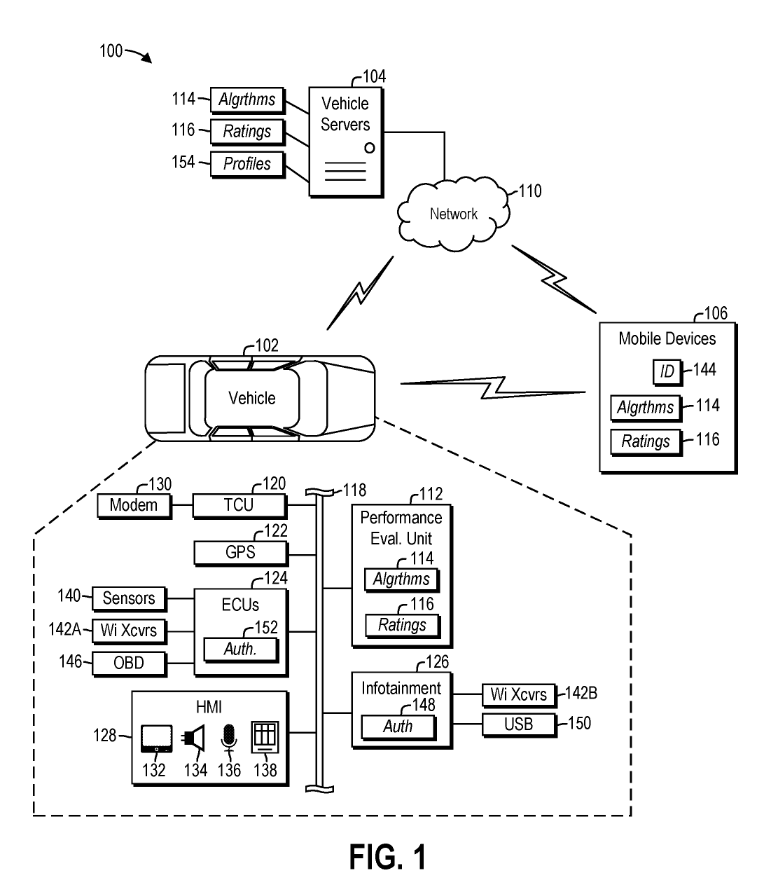

FIG. 1 illustrates an exemplary system 100 for evaluating driver performance while maintaining driver privacy. The system 100 may include a vehicle 102 configured to compute a performance rating for a driver by applying a performance algorithm installed on the vehicle 102 to collected driving behavior data, which may include information that the driver desires to remain unshared. The vehicle 102 may also be configured to transmit the performance rating, but not the driving behavior data, to a vehicle server 104 specific to the installed performance algorithm, which may utilize the driver's performance rating to adjust services provided to the driver. The particular and unconventional arrangement of technological components in the system 100, such as the application of the performance algorithm at the vehicle 102 rather than at the vehicle server 104, enables drivers to view, possibly in real time or near real time, how their driving affects their performance rating and, correspondingly, services provided via the vehicle servers 104. Moreover, this arrangement enables the vehicle servers 104 to adjust provided services based on a driver's performance without the driver's driving behavior data being transmitted offboard the vehicle, which protects the driver's privacy.

The system 100 may include one or more of the vehicle 102, one or more vehicle servers 104, and one or more mobile devices 106. Each of these system 100 components may communicate with one or more of the other components directly and/or over the network 110. The network 110 may include one or more interconnected communication networks, such as one or more of the Internet, a cable television distribution network, a satellite link network, a local area network, a wide area network, and a telephone network.

The vehicle 102 may include various types of automobile, crossover utility vehicle (CUV), sport utility vehicle (SUV), truck, recreational vehicle (RV), boat, plane, E-bike, or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). The vehicle 102 may also be an autonomous vehicle (AV). As the type and configuration of vehicle 102 may vary, the capabilities of the vehicle 102 may correspondingly vary. For example, different vehicles 102 may have different capabilities with respect to passenger capacity, towing ability and capacity, and storage volume. For title, inventory, and other purposes, the vehicle 102 may be associated with and store therein a unique identifier, such as a Vehicle Identification Number (VIN).

The vehicle 102 may include a performance evaluation unit 112 configured to perform instructions, commands, and other routines in support of the processes described herein. For example, the performance evaluation unit 112 may be configured to calculate a performance rating 116 based on collected driving behavior data and a stored performance algorithm 114, and may be configured to cause the vehicle 102 to transmit the performance rating 116 to the vehicle server 104 that is specific to the stored performance algorithm 114 and provides services for the vehicle 102 or driver.

The performance evaluation unit 112 may be configured to communicate with other vehicle 102 components via one or more in-vehicle networks 118. The in-vehicle networks 118 may include one or more of a vehicle controller area network (CAN), an Ethernet network, and a media oriented system transfer (MOST) network. The other vehicle 102 components may include one or more of a telematics control unit (TCU) 120, a global positioning system (GPS) module 122, various electronic control units (ECUs) 124, an infotainment system 126, and a human machine interface (HMI) 128.

The TCU 120 of the vehicle 102 may be configured to facilitate wireless communication between the other vehicle 102 components and other components of the system 100 over the network 110. To this end, the TCU 120 may operate an embedded cellular modem 130 or another wireless network transceiver (e.g., Wi-Fi transceiver) configured to connect to the network 110, such as over a cellular network to which the cellular modem 130 is subscribed. The other vehicle 102 components may access the communication capabilities of the TCU 120, and thus communicate with other components of the system 100, over the in-vehicle networks 118.

The GPS module 122 of the vehicle 102 may be configured to identify vehicle 102 geographical data, such as via communicating with one or more satellites over a satellite link network. The vehicle 102 geographical data may include a current location (e.g., latitude and longitude coordinates, street address, nearest intersection) and bearing of the vehicle 102. The GPS module 122 may be configured to provide the vehicle 102 geographical data to the other vehicle 102 components, such as the infotainment system 126 or the performance evaluation unit 112, automatically or on request.

The vehicle ECUs 124 may be configured to monitor and manage various functions of the vehicle 102 under the power of the vehicle 102 battery and/or drivetrain. The vehicle ECUs 124 may include, but are not limited to, a radio transceiver controller configured to communicate with mobile devices 106 and other local vehicle 102 devices; a powertrain controller configured to monitor and manage engine operating components; a body controller configured to monitor and manage various power control functions such as exterior lighting, interior lighting, keyless entry, remote start, and point of access status verification; and a climate management controller configured to monitor and manage heating and cooling system components (e.g., compressor clutch, blower fan, temperature sensors).

The infotainment system 126 may be configured to provide entertainment and informational services to a user, such as via a graphical user interface (“GUI”) shown on a display (e.g., the display 132) driven by the infotainment system 126. For example, the infotainment system 126 may be configured to provide in-vehicle services such as navigation, radio, playing music from a connected mobile device 106, in-vehicle apps based on Internet content retrieved via a connected mobile device 106 or via the TCU 120, hands-free mobile device 106 calling, and voice command recognition. The infotainment system 126 may also enable users to view operational data relating to the vehicle 102, such as from the vehicle ECUs 124, and to customize operation of the vehicle 102, such as by communicating received user input to the other vehicle 102 components.

The HMI 128 may facilitate occupant interaction with one or more the other vehicle 102 components. For example, the HMI 128 may include one or more video and alphanumeric displays 132, a speaker system 134, and any other suitable audio and visual indicators capable of providing data from the other vehicle 102 components to the user. The HMI 128 also include a microphone 136, physical controls 138, and any other suitable mechanisms for receiving input from a user to invoke functions of the other vehicle 102 components. The physical controls 138 may include, without limitation, an alphanumeric keyboard, a pointing device (e.g., mouse), keypads, pushbuttons, and control knobs. As an example, the physical controls 138 may include steering wheel audio buttons, a push-to-talk button, instrument panel controls, and the like. The displays 132 of the vehicle 102, which may include a center console display and/or a steering wheel display, may also include a touch screen mechanism for receiving user input.

The vehicle 102 may also include vehicle sensors 140. The vehicle sensors 140 may be configured to generate data indicating driving behaviors associated with the vehicle 102 over a given period. For example, the vehicle sensors 140 may include, without limitation, a speed sensor configured to measure a speed of the vehicle 102, an accelerometer configured to measure an acceleration level of the vehicle 102, an odometer configured to measure a distance traveled by the vehicle 102, a tachometer configured to measure a working speed of the vehicle 102 engine, a gyroscope or compass configured to identify a direction of the vehicle 102, an impact sensor configured to identify collisions of the vehicle 102, and airbag sensors configured to identify deployment of the airbags of the vehicle 102. The GPS module 122, which may identify geographical data for the vehicle 102, may also be considered as a sensor of the vehicle 102 configured to generate data indicative of driving behaviors.

The vehicle sensors 140 may be operatively coupled to the performance evaluation unit 112. Specifically, the vehicle sensors 140 may provide sensed driving behavior data to the vehicle ECUs 124, which may be configured to format and/or communicate the sensed driving behavior data to the performance evaluation unit 112. Alternatively, one or more of the vehicle sensors 140 may be directly connected to the performance evaluation unit 112. The performance evaluation unit 112 may be configured to compute a performance rating 116 for a driver based on the received driving behavior data from the vehicle sensors 140.

The vehicle 102 may also include one or more wireless transceivers 142 configured to facilitate direct wireless communication with other components of the system 100, such as when these other components are local to (e.g., within direct wireless communication range of) the wireless transceivers 142. For example, one or more of the vehicle ECUs 124, such as the radio transceiver controller, and/or the infotainment system 126, may each be operatively coupled to wireless transceivers 142.

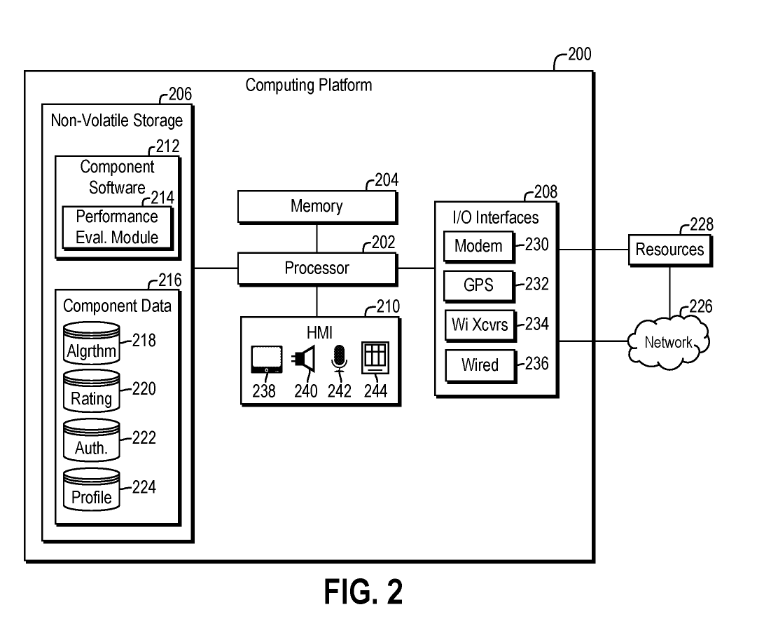

The mobile devices 106 may include a mobile personal computing device such as a mobile phone, tablet, or laptop, and may include a key fob programmed to the vehicle 102. Each mobile device 106 may likewise include one or more wireless transceivers, such as the wireless transceivers 234 shown in FIG. 2. The wireless transceivers 234 of the mobile devices 106 may correspond to the wireless transceivers 142 of the vehicle 102, and may thus be configured to enable direct wireless communication between the vehicle 102 and the mobile devices 106. The wireless transceivers 142 of the vehicle 102 and the wireless transceivers 234 of the mobile devices 106 may communicate via RF transmissions and may each include, without limitation, one or more of a Bluetooth transceiver, a ZigBee transceiver, a Wi-Fi transceiver, a radio-frequency identification (“RFID”) transceiver, a near-field communication (“NFC”) transceiver, and a transceiver designed for another RF protocol particular to a remote service provided by the vehicle 102 (e.g., keyless entry, remote start, passive entire passive start).

For example, responsive to a user interaction indicating a remote control command for the vehicle 102 with a mobile device 106, the mobile device 106 may be configured to directly and wirelessly transmit a command request to the vehicle 102 via the wireless transceivers 142A. The command request may indicate a desired action for the vehicle 102, such as an unlock request, a trunk open request, a lock request, a remote start request, or a panic request. The command request may also include an ID 144 stored in the mobile device 106. The ID 144 may be an alphanumeric code, and may be encrypted.

The vehicle 102 may be configured to receive and process the command request when the vehicle 102 is in an off state or in an on state. Responsive to receiving the command request, the vehicle ECUs 124, such as the radio transceiver controller, may be configured determine whether the mobile device 106 is authorized to make the command. For example, the ECUs 124 may be configured to compare the received ID 144 with stored authorization data 152 to determine if a match exists. As part of this authorization process, the ECUs 124 may be configured to decrypt the received ID 144. If a match exists, then the ECUs 124 may be configured implement the command. For example, if the command is an unlock request, then the radio transceiver controller may be configured to communicate a message to the body controller that causes the body controller to unlock the vehicle 102. If the command is a remote start request, then the radio transceiver controller may be configured to communicate a message to the powertrain controller that causes the powertrain controller to start the vehicle 102 engine.

As a further example, the wireless transceivers 142A may include several wireless transceivers arranged around the vehicle 102, such as near vehicle 102 access points (e.g., trunk release, door handle, engine start button or ignition slot). Each of these wireless transceivers may be associated with its nearby access point. When a mobile device 106 comes into wireless communication range of one of these wireless transceivers, or when the mobile device 106 is placed within the vehicle 102 ignition slot and rotated, the mobile device 106 may be configured to automatically transmit its ID 144 to the vehicle ECUs 124, such as the radio transceiver controller, via the in-range wireless transceiver.

Responsive to receiving the ID 144, and to determining that the ID 144 matches the authorization data 152, the ECUs 124 may be configured to enable the access point associated with the receiving wireless transceiver, such as by communicating an enablement signal to the vehicle 102 component for the associated access point, at least until the ID 144 ceases to be received via the wireless transceiver. For example, if the ID 144 is received via a wireless transceiver associated with a given vehicle 102 door handle, then the ECUs 124 may be configured to cause the body controller to unlock the vehicle 102 upon a user interaction with the door handle, such as by communicating an enablement signal to the body controller. As another example, if the ID 144 is received by a wireless transceiver associated with a vehicle 102 start button or ignition, then the ECUs 124 may be configured to cause the powertrain controller to start the vehicle 102 upon interaction with the start button or rotation within the ignition, respectively, such as by sending an enablement signal to the powertrain controller.

As a further example, the wireless transceivers 142B operatively coupled to the infotainment system 126 may be configured to directly connect and communicate with a corresponding wireless transceiver (e.g., wireless transceivers 234 of FIG. 2) of a mobile device 106 to provide services based on data from the mobile device 106. To this end, the infotainment system 126 may include authorization data 148 indicative of mobile devices 106 that are authorized to connect and communicate with the infotainment system 126. For example, the authorization data 148 may include the ID 144 of the mobile device 106, and may include other credentials such as Wi-Fi settings (e.g., SSID and password). Responsive to receiving the appropriate credentials from the mobile device 106, the infotainment system 126 may enable a wireless connection to be established between the infotainment system 126 and the mobile device 106 via the wireless transceivers 142B.

The wireless connection formed between the infotainment system 126 and the mobile device 106, which may be a Bluetooth connection, may enable the provision of services by the infotainment system 126 such as, without limitation, hands-free telephone calling, music streaming, and in-vehicle applications reliant on content from the mobile device 106. Moreover, this wireless connection, which may be a Wi-Fi connection, may function to share an Internet connection of the vehicle 102 (which may be established via the TCU 120) with the mobile device 106. Additionally, in some embodiments, rather than communicating over the network 110 via the cellular modem 130 of the TCU 120, the vehicle 102 components may be configured to communicate over the network 110 through a local connection formed between the infotainment system 126 and the mobile device 106 and through an Internet connection of the mobile device 106. To this end, the mobile device 106 may include a cellular modem, such as the cellular modem 230 shown in FIG. 2, or another wireless transceiver (e.g., a Wi-Fi transceiver), configured to connect with and communicate over the network 110.

The vehicle 102 may likewise include one or more wired interfaces for forming local connections with a mobile device 106. For example, the vehicle 102 may include an on-board diagnostics (OBD) interface 146 operatively coupled to the ECUs 124. The OBD interface 146 may be configured to provide a connected mobile device 106 with diagnostic information relating to the vehicle 102 components. Specifically, if an ECU 124 or other vehicle 102 component detects an erroneous or hazardous condition relating to the vehicle 102, the ECU 124 or other vehicle 102 component may log a code indicative of the problem, and may restrict operation of the vehicle 102 until the issue is resolved. A technician or other user may thereafter connect a mobile device 106 to the OBD interface 146 to retrieve the logged code and identify and resolve the issue. As a further example, the vehicle 102 may include a universal serial bus (“USB”) interface 150 operatively coupled to the infotainment system 126. A user may connect a mobile device 106 to the USB interface 150, and thereby exchange information with the infotainment system 126 and the other vehicle 102 components. This information exchange may enable the infotainment system 126 to provide many of the in-vehicle services described above (e.g., playing music stored on the mobile device 106).

The vehicle servers 104 may be configured to facilitate the provision of services for the vehicle 102 or drivers of the vehicle 102 that relate to driving performance. For example, each vehicle server 104 may facilitate the provision of usage based insurance by a different insurer, and may correspondingly be configured to store and automatically adjust policies based on received performance ratings 116. Each vehicle server 104 may serve a different one or more drivers and/or vehicles, and may maintain and manage one or more performance algorithms 114 assigned to the drivers and/or vehicles served by the vehicle server 104. A given vehicle server 104 may assign different performance algorithms 114 to different vehicle types and/or driver types. Each performance algorithm 114 may have an exposed construct with global variables that can be updated with driving behavior data collected by a vehicle 102 while it is being operated, and may be configured to produce a performance rating 116 based on the collected driving behavior data.

Each vehicle server 104 may also manage and store at least one performance rating 116 for each driver and/or vehicle served by the vehicle server 104. Each vehicle server 104 may further maintain a profile 154 for each driver and/or vehicle served by the vehicle server 104. A profile 154 may identify one or more drivers and/or one or more vehicles, the one or more performance ratings 116 for the one or more drivers and/or one or more vehicles, and a performance algorithm 114 assigned to the one or more drivers and/or one or more vehicles. In the example where each vehicle server 104 facilitates the provision of usage base insurance, each profile 154 may also include rate information indicating a cost of a policy covering the vehicles and/or drivers in the profile 154.

During operation of the system 100, one of the vehicle servers 104 may receive a request for a performance algorithm 114 and/or a performance rating 116 associated with the vehicle 102 or a driver served by the vehicle server 104. The request may be received over the network 110 from either a mobile device 106 or the vehicle 102, and may include an identifier for the vehicle 102 or particular driver. Responsive to receiving the request, the one vehicle server 104 may transmit the performance algorithm 114 and/or the performance rating 116 for the vehicle 102 and/or driver to the requesting system 100 component over the network 110. If the requesting system 100 component is a mobile device 106, responsive to receiving the performance algorithm 114 and/or the performance rating 116, the mobile device 106 may transfer this data to the vehicle 102, or more particularly to the performance evaluation unit 112, via a local connection formed between the mobile device 106 and vehicle 102.

Thereafter, while the vehicle 102 is being operated, the performance evaluation unit 112 may collect driving behavior data at least via the vehicle sensors 140. The performance evaluation unit 112 may then calculate a new performance rating 116 for the driver and/or vehicle 102 based on the driving behavior data and the downloaded performance algorithm 114. The performance evaluation unit 112 may thereafter cause the vehicle 102 to transmit the new performance rating 116 to the one vehicle server 104 over the network 110. Responsive to receiving the new performance rating 116 for the driver and/or vehicle 102, the vehicle server 104 may store the new performance rating 116 in association with the driver and/or vehicle 102, such as in the profile 154 for the driver and/or vehicle 102.

The vehicle servers 104 may also be configured to automatically adjust the profile 154 for a driver and/or vehicle 102 based on the updated performance rating 116. For example, if the received performance rating 116 indicates that the driver and/or vehicle 102 engaged in increasingly aggressive behavior, a vehicle server 104 may be configured raise rates for a usage based insurance policy covering the driver and/or vehicle 102. Alternatively, if the received performance rating 116 indicates that the driver and/or vehicle 102 engaged in increasingly cautious behavior, the vehicle server 104 may be configured lower rates for the usage based insurance policy covering the driver and/or vehicle 102.

While an exemplary system 100 is shown in FIG. 1, the example is not intended to be limiting. Indeed, the system 100 may have more or fewer components, and alternative components and/or implementations may be used. For instance, vehicle 102 components may be combined such that one of the vehicle 102 components is configured to implement as least some or all of the described functions of one or more other vehicle 102 components. As an example, the infotainment system 126 and/or one or more of the ECUs 124 may be configured to provide at least some of the described functionality of the HMI 128. Specifically, the infotainment system 126 may directly drive and receive input via a center counsel touch screen display 132, and at least a portion of the physical controls 138 may be directly connected to and control one or more of the ECUs 124. As a further example, one or more of the vehicle 102 components, such as the infotainment system 126, the TCU 120, and/or one or more of the ECUs 124, may be configured to implement at least some or all of the described functionality of the performance evaluation unit 112. In other words, the functions of the performance evaluation unit 112 may be spread across two or more of the infotainment system 126, the TCU 120, and one or more of the ECUs 124.

Referring to FIG. 2, the vehicle 102 components, such as the performance evaluation unit 112, the TCU 120, the GPS module 122, the vehicle ECUs 124, the HMI 128, and the infotainment system 126, and the other system 100 components, such as the vehicle servers 104 and the mobile devices 106, may each be implemented by one or more computing platforms, such as the computing platform 200. For example, each vehicle 102 component may be implemented by a different computing platform 200 connected to the in-vehicle networks 118. As another example, two or more of the vehicle 102 components may be implemented by a same computing platform 200 connected to the in-vehicle networks 118, such as if two or more vehicle 102 components are combined as described above.

A given computing platform 200 of the system 100 may include a processor 202, memory 204, non-volatile storage 206, I/O interfaces 208, and an HMI 210. The processor 202 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 204. The memory 204 may include a single memory device or a plurality of memory devices including, but not limited, random access memory (“RAM”), volatile memory, non-volatile memory, static random access memory (“SRAM”), dynamic random access memory (“DRAM”), flash memory, cache memory, or any other device capable of storing information. The non-volatile storage 206 may include one or more persistent data storage devices such as a hard drive, optical drive, tape drive, non-volatile solid state device, or any other device capable of persistently storing information.

The processor 202 may be configured to read into memory 204 and execute computer-executable instructions embodying component software 212 residing in the non-volatile storage 206. The component software 212 of a given computing platform 200, upon execution by the processor 202 of the given computing platform 200, may be configured to cause the given computing platform 200 to implement the functions, features, and processes of the component or components being implemented by the given computing platform 200. For example, the component software 212 for the infotainment system 126 may be configured upon execution to cause a given computing platform 200 of the vehicle 102 to implement in-vehicle features such as navigation, radio, streaming music from a connected mobile device 106, in-vehicle apps based on content from a connected mobile device 106, voice commands, and hands-free telephone calling.

The component software 212 of a given computing platform 200 may include an operating system and/or one or more applications. The computer-executable instructions of the component software 212 may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The component software 212 of a given computing platform 200 may be configured upon execution to cause the given computing platform 200 to implement one or more modules, such as a performance evaluation module 214. Each module may represent a process executed by the processor 202 of the given computing platform 200. The performance evaluation module 214, which may be implemented by a computing platform 200 for the performance evaluation unit 112, may be configured to implement the functionality of the performance evaluation unit 112, such as computing a performance rating 116 by applying sensed driving behavior data to a previously received and stored performance algorithm 114, and causing the vehicle 102 to transmit the computed performance rating 116 (but not the driving behavior data) to the vehicle server 104 specific to the applied performance algorithm 114.

The non-volatile storage 206 of a given computing platform 200 may also include component data 216, which may be utilized by the various system 100 components and vehicle 102 components to provide the functions and features described herein. Specifically, the component software 212 of a given computing platform 200 may access the component data 216 of the given computing platform 200 to provide the functions and features of the implemented component. For example, depending on the component being implemented by a given computing platform 200, the component data 216 of the given computing platform 200 may include one or more of the performance algorithms 114, performance ratings 116, profiles 154, the ID 144, the authorization data 148, and the authorization data 152 shown in FIG. 1.

The non-volatile storage 206 of a given computing platform 200 may include one or more databases used to collect and organize the component data 216. These databases may include supporting data structures that store and organize the utilized data. A database management system in the form of computer software executing as instructions on the processor 202 may be used to access the information or stored data records of the databases in response to a query, where a query may be dynamically determined and executed by the component software 212.

For example, the non-volatile storage 206, such as for a vehicle server 104, a mobile device 106, and the performance evaluation unit 112, may include an algorithm database 218. The algorithm database 218 may indicate one or more drivers and/or vehicles, and may associate each driver and/or vehicle with a performance algorithm 114. Drivers may be represented as driver identifiers within the algorithm database 218, and vehicles may be represented as their VINs within the algorithm database 218. As a further example, the non-volatile storage 206, such as for a vehicle server 104, a mobile device 106, and the performance evaluation unit 112, may include a rating database 220. The rating database 220 may indicate one or more drivers and/or vehicles, and may associate each driver and/or vehicle with one or more performance ratings 116 that have been calculated for the driver and/or vehicle. As an additional example, the non-volatile storage 206, such as for a vehicle server 104, may include a profile database 224, which may include the profiles 154 shown in FIG. 1. Although illustrated as separate databases, one or more these databases may be combined into single database maintained by the vehicle servers 104, the mobile devices 106, and/or the performance evaluation unit 112.

As another example, the non-volatile storage 206 may include an authorization database 222. The authorization database 222, which may be included in the non-volatile storage 206 for the vehicle ECUs 124 or the infotainment system 126, may include the authorization data 152 or the authorization data 148 respectively. An authorization database 222 for the vehicle ECUs 124 may include a list of credentials, such as a list of IDs 144, that are authorized to remotely command the vehicle 102 via the wireless transceivers 142A coupled to the vehicle ECUs 124. An authorization database 222 for the infotainment system 126 may likewise include credentials, such as a list of IDs 144 and/or Wi-Fi settings, that are authorized to connect to the infotainment system 126 via the wireless transceivers 142B coupled to the infotainment system 126.

The I/O interfaces 208 may provide one or more machine interfaces that operatively couple a computing platform 200, or more particularly the component implemented by the computing platform 200, to other devices and systems, such as a network 226 or external resources 228. The network 226 may include the one or more in-vehicle networks 118 and/or the network 110 shown in FIG. 1, and the external resources 228 may include the computing platform 200 of another system 100 component or of another vehicle 102 component. The component software 212 of a given computing platform 200 may thus work cooperatively with the network 226 and the external resources 228 by communicating via the I/O interfaces 208 to provide the various features, functions, applications, processes, and modules described herein. For example, the component software 212 may have program code that is executed by the external resources 228, or may otherwise rely on functions or signals provided by other system or network components external to the computing platform 200.

The I/O interfaces 208 may include a cellular modem 230, which may include the cellular modem 130 of the vehicle 102 or may be configured similar to the cellular modem 130 (e.g., configured to connect to the network 110 over a cellular network to which the cellular modem 230 is subscribed). The I/O interfaces 208 may also include a GPS module 232, which may include the GPS module 122 of the vehicle 102 or may be configured similar to the GPS module 122 (e.g., configured to identify geographical data of the computing platform 200, such as via communicating with one or more satellites over a satellite link network). The I/O interfaces 208 may also include wireless transceivers 234, which may include the wireless transceivers 142 of the vehicle 102 or may be configured similar to the wireless transceivers 142 (e.g., include wireless transceivers having protocols corresponding to the wireless transceivers 142 to enable connection and communication with the wireless transceivers 142).

The I/O interfaces 208 may also include one or more wired I/O interfaces 236, which may include, without limitation, one or more of an ethernet interface, a CAN interface, and a MOST interface. In addition, the wired I/O interfaces 236 may include the USB interface 150 of the vehicle 102 or may include a USB interface for connecting to the USB interface 150 of the vehicle 102 (e.g., when the computing platform 200 is for a mobile device 106); may include the OBD interface 146 of the vehicle 102 or may include an OBD interface for connecting to the OBD interface 146 of the vehicle (e.g., when the computing platform 200 is for a mobile device 106); and may include an auxiliary (AUX) interface (e.g., when the computing platform 200 is for a mobile device 106 or for the infotainment system 126 of the vehicle 102), such as to facilitate wired audio connections between the infotainment system 126 and the mobile device 106.

The HMI 210 of a given computing platform 200 may facilitate user interaction with the vehicle 102 component or system 100 component being implemented by the given computing platform 200. The HMI 210 may include or be configured similarly to the HMI 128 of the vehicle 102, and may thus include one or more video and alphanumeric displays 238, a speaker system 240, and any other suitable audio and visual indicators capable of providing data from the vehicle 102 component or the system 100 component to the user. The HMI 210 may likewise include a microphone 242 and physical controls 244, which may include an alphanumeric keyboard, a pointing device (e.g., mouse), keypads, pushbuttons, and control knobs, that are capable of accepting commands or input from a user to invoke functions of the vehicle 102 component or the system 100 component. At least one of the displays 238 may also include a touch screen mechanism for receiving user input.

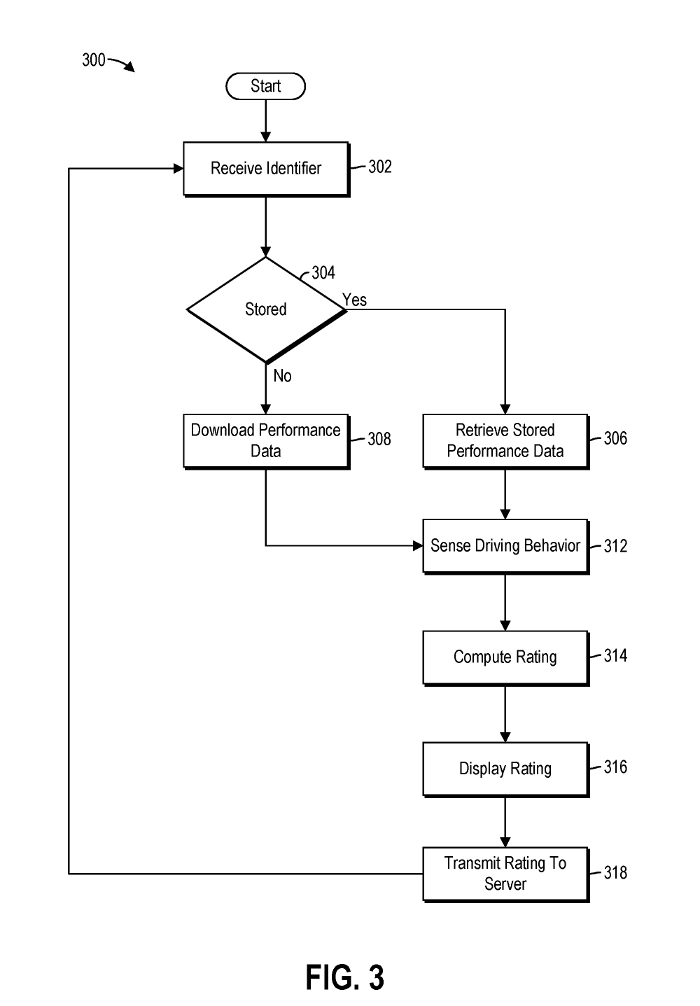

FIG. 3 illustrates a process 300 that may be performed by the system 100 of FIG. 1. In block 302, the vehicle 102, or more particularly the performance evaluation unit 112, may receive an identifier for a particular driver of the vehicle 102 or an identifier for the vehicle 102. For example, each driver of the vehicle 102 may be associated with a different identifier, which in turn may be associated with a performance algorithm 114 and historic performance ratings 116 within the performance evaluation unit 112 and/or one of the vehicle servers 104. A vehicle server 104 serving multiple drivers may assign different performance algorithms 114 to each driver based on the driver's driving history, the driver's personal characteristics (e.g., age, sex), the type of the driver's primary vehicle 102, and/or the type of service provided to the driver (e.g., level of insurance policy coverage). The identifier for each driver of the vehicle 102 may be the ID 144 stored on a mobile device 106 utilized by the driver to control the vehicle 102, and may be received via the wireless transceivers 142 of the vehicle 102 when the mobile device 106 wirelessly interacts with the wireless transceivers 142, such as to unlock or start the vehicle 102, or to connect to the infotainment system 126. Alternatively, upon the vehicle 102 being started, the infotainment system 126 may display a GUI on the display 132 that enables a driver to input his or her identifier to the performance evaluation unit 112.

In addition, or alternatively, to being driver specific, the performance algorithms 114 and performance ratings 116 may be vehicle-specific, and may be assigned based on the type of vehicle 102 and the driving history and personal characteristics of one or more drivers registered to use the vehicle 102, such as indicated in a profile 154 for the vehicle 102. In this case, the identifier received in block 302 may be specific to the vehicle 102 (e.g., VIN). For example, responsive to the vehicle 102 being started, the performance evaluation unit 112 may be configured to retrieve the vehicle 102 identifier from in-vehicle storage, such as the non-volatile storage 206 for the performance evaluation unit 112.

In block 304, the performance evaluation unit 112 may determine whether performance data for the received identifier (e.g., a performance algorithm 114 and/or historic performance rating 116) is stored in the vehicle 102, such as in the component data 216 for the performance evaluation unit 112. For example, the performance evaluation unit 112 may query one or more databases maintained by the performance evaluation unit 112, such as an algorithm database 218 and/or a rating database 220, based on the received identifier. If performance data is stored in the vehicle (“Yes” branch of block 304), then in block 306, the performance evaluation unit 112 may retrieve the stored performance data from the in-vehicle storage. If not (“No” branch of block 304), then in block 308, the performance evaluation unit 112 may download the performance data from the vehicle servers 104 over the network 110. In particular, the performance evaluation unit 112 may transmit the identifier to the vehicle servers 104, which may responsively transmit the performance data associated with the identifier to the performance evaluation unit 112 over the network 110. If only some of the performance data, such as the performance algorithm 114, is currently stored on the vehicle 102, then the performance evaluation unit 112 may download the missing performance data, such as the historic performance rating 116, over the network 110.

Notwithstanding whether the in-vehicle storage already includes performance data corresponding to a received identifier, responsive to the vehicle 102 being started and receiving the identifier, the performance evaluation unit 112 may be configured to query the vehicle servers 104 for whether the performance data for the identifier stored on the vehicle 102 is outdated. For example, the query may indicate the identifier and the performance data currently stored on the vehicle 102 for the identifier, a last update time recorded for the performance data currently stored on the vehicle 102 for the identifier, or a version number associated with the performance data currently stored on the vehicle 102 for the identifier for comparison with similar items stored by the vehicle servers 104 in relation to the performance data for the identifier. If the vehicle servers 104 determine that the performance data stored on the vehicle 102 for the identifier is outdated based on the comparison, then the vehicle servers 104 may transmit the updated performance data (e.g., updated performance algorithm 114, updated performance rating 116) to the performance evaluation unit 112. This situation may occur, for example, if a driver associated with the received identifier damaged or received a citation in relation to driving the vehicle 102 or another vehicle, or utilized another vehicle 102 in an aggressive manner since last utilizing the vehicle 102.

In some embodiments, the identifier received in block 302 may be an identifier submitted by a user to a mobile device 106, which may be configured to responsively request a performance algorithm 114 and a historic performance rating 116 associated with the identifier from the vehicle servers 104. Responsive to receiving this performance data, the mobile device 106 may pass this performance data to the vehicle 102, such as via a local connection formed with the vehicle 102. In some embodiments, the mobile device 106 may be a special-purpose device specific to storing performance data for a given driver or the vehicle 102. Whenever the performance data for the driver or vehicle 102 is updated, either on the side of the vehicle servers 104 or by the vehicle 102, the updated performance data may be transmitted to this mobile device 106 from the vehicle servers 104 or the vehicle 102, respectively.

Because the system 100 may include several vehicle servers 104 each serving different drivers and/or vehicles, the system 100 may be configured to route communications for a given driver or vehicle to the appropriate vehicle server 104. For instance, the identifier received by the vehicle 102 or the mobile device 106 in block 302 may also indicate one of the vehicle servers 104, such that the vehicle 102 or the mobile device 106 is able to identify the vehicle server 104 serving the given driver or vehicle from the available vehicle servers 104 based on the identifier. As a non-limiting example, the performance evaluation unit 112 or the mobile device 106 may maintain a table that associates each identifier with a particular vehicle server 104 in which to communicate. As another example, the infotainment system 126 or mobile device 106 may be configured to present a GUI, such as via the display 132 of the vehicle 102 or the display 238 of the mobile device 106 respectively, that enables a user to enter an indication of a vehicle server 104, such as via entering a code for an entity (e.g. insurance company) maintaining a vehicle server 104 or entering a network address (e.g., a uniform resource locator, or “URL”) for a vehicle server 104. The performance evaluation unit 112 or mobile device 106 may then communicate with the indicated vehicle server 104 based on the entered data.

Alternatively, one of the vehicle servers 104 may act as a routing server that receives all requests for performance data. This vehicle server 104 may maintain a routing database indicating which vehicle server 104 serves which drivers and/or vehicles. Responsive to receiving a request for performance data including an identifier for a driver or a vehicle, the vehicle server 104 acting as the routing server may be configured to query the routing database based on the identifier to identify the vehicle server 104 facilitating services, such as insurance services, for the identifier. The vehicle server 104 acting as the routing server may thereafter communicate the request to the identified vehicle server 104. This process may similarly occur responsive to receiving an updated performance rating 116 for a driver or vehicle from the vehicle 102 or a mobile device 106.

In block 312, data indicative of driving behaviors may be generated and collected. In particular, while the vehicle 102 is being driven, the performance evaluation unit 112 may collect and store driving behavior data generated by the vehicle sensors 140. The collected driving behavior data may thus include, without limitation, speed values of the vehicle 102 recorded during a trip, acceleration values of the vehicle 102 recorded during a trip, distance traveled values of the vehicle 102 recorded during a trip, a number and/or an indication of collision events occurring during a trip, a number and/or an indication of airbag deployment events occurring during a trip, and engine working speed values of the vehicle 102 recorded during a trip. Each value and adverse event (e.g., collision event, airbag deployment event) indicated by the driving behavior data may be associated within the driving behavior data with a time and/or location indicating when and where the value or adverse event occurred, such as based on geographic data received from the GPS module 122.

The performance evaluation unit 112 may be configured, such as at the direction of a currently applied performance algorithm 114, to identify when any of the values or numbers indicated in the driving behavior data is greater than a set threshold value, which may be defined by the currently applied performance algorithm 114. The performance evaluation unit 112 may also be configured, such as at the direction of a currently applied performance algorithm 114, to identify sudden changes to the values or numbers, which may be identified when a change occurs that is greater than a set threshold value and within a set time period (e.g., a sudden breaking event that causes the speed of the vehicle 102 to decrease by a value that is greater than a set threshold value within a set time period).

The driving behavior data may thus represent when a driver performs aggressive maneuvers during a trip, such as by indicating how often the driver excessively accelerates (e.g., acceleration measurement greater than a set threshold value, speed measurement change greater than a set threshold value within a set time period), how often the driver hard breaks (e.g., deceleration measurement greater than a set threshold value, speed measurement change beyond a set threshold within a set time period), and if the driver travels at dangerously fast speeds (e.g., speed measurement greater than a set threshold value, which may be based on a current speed limit in which the vehicle 102 is located). The rules for identifying aggressive maneuvers from the driving behavior data based on defined parameters, such as the set comparative threshold values described above, may be defined in the performance algorithm 114 for the current driver or vehicle 102.

The performance evaluation unit 112 may also be configured, such as at the direction of a currently applied performance algorithm 114, to determine if identified aggressive maneuvers and adverse events occur during turns or non-turns. The performance evaluation unit 112 may be configured to make this determination based on the driving behavior data indicative of the steering wheel positions and/or of directions of the vehicle 102 at times corresponding to the driving behavior data representative of aggressive maneuvers or events.

The collected driving behavior data may also include locations of the vehicle 102 during a trip, such as based on geographical data received from the GPS module 122, and may include timing data indicative of when the vehicle 102 is being driven and where the vehicle 102 is located at a given time. The performance evaluation unit 112 may be configured to utilize this data, such as at the direction of a currently applied performance algorithm 114, to identify adverse events of undesirable operating conditions of the vehicle 102. The rules for identifying adverse events from the driving behavior data based on defined parameters, such as an undesirable location or operation of the vehicle at a given time, may be defined in the performance algorithm 114 for the current driver or vehicle 102.

For example, the performance evaluation unit 112, such as at the direction of a currently applied performance algorithm 114, may be configured determine whether the driver directs the vehicle 102 to an undesirable area, which may be time-dependent (e.g., dangerous area at night), and whether the driver operates the vehicle 102 under physically straining conditions (e.g., continuous operation of the vehicle 102 for a period greater than a set duration threshold and/or during a set period of day such as after dark). Moreover, the performance evaluation unit 112, such as at the direction of a currently applied performance algorithm 114, may derive a trip distance from the geographical data, and determine, based on the distance and the timing data, whether the driver operated the vehicle 102 at dangerously fast speeds during the trip (e.g., the driver drove from location A to location B in a time that is less than a set minimum safe driving time for the locations).

In block 314, an updated performance rating 116 for the current driver or vehicle 102 (or new performance rating 116, if no rating has yet been calculated for the current driver or vehicle 102) may be computed. Specifically, the performance evaluation unit 112 may apply the collected driving behavior data and the previous performance rating 116 for the current driver or vehicle 102 (or a default performance rating 116 received from the vehicle servers 104, if no rating has yet been calculated for the current driver or vehicle 102) to the performance algorithm 114 for the current driver or the vehicle 102. The performance algorithm 114 may cause the performance evaluation unit 112 to identify the occurrence of aggressive maneuvers and adverse events from the driving behavior data as described above, and may cause the performance evaluation unit 112 to compute a performance rating 116 for the driver or the vehicle 102 based on the identified aggressive maneuvers and adverse events, and on the previous (or default) performance rating 116.

As an example, the performance algorithm 114 may set forth a threshold number, and if the driving behavior data indicates the occurrence of aggressive maneuvers during a trip is greater than the threshold number, the performance algorithm 114 may be configured to adjust the previous performance rating 116 for the driver or vehicle 102 to indicate a poorer performance level. The adjustment may be in proportion to the number of instances of aggressive maneuvers above the set threshold number. The adjustment may also depend on whether the aggressive maneuver occurred during a turn. For example, aggressive maneuvers occurring during turns may result in a larger negative adjustment, or may be associated with a lower threshold number such that fewer aggressive maneuvers causes an adjustment. The performance algorithm 114 may also associate the threshold number with a threshold time span, such that a negative adjustment may occur responsive to a number of aggressive maneuvers occurring within the threshold time span that is greater than the threshold number.

The performance algorithm 114 may also set forth a threshold number for different types of aggressive maneuvers (e.g., hard breaking and excessive acceleration, each occurring at least a set number of times), and if the driving behavior data indicates a number of occurrences of each different type of aggressive maneuver greater than the threshold number for that type of aggressive maneuver, the performance algorithm 114 may be configured to adjust the performance rating 116 for the driver or vehicle 102 to indicate a poorer performance level, such as in proportion to the number of occurrences above the threshold numbers. The performance algorithm 114 may further set forth a threshold time span for different types of aggressive maneuvers (e.g., hard breaking and excessive acceleration occurring within two seconds of each other), and if the driving behavior data indicates that each type of aggressive maneuver occurred within the threshold time span, the performance algorithm 114 may be configured to adjust the performance rating 116 for the driver or vehicle 102 to indicate a poorer performance level, such as in proportion to the number of times each type of aggressive maneuver occurs within the threshold time span.

The performance algorithm 114 may also be configured to adjust the performance rating 116 for the driver or vehicle 102 to indicate a poorer performance level responsive to identifying an adverse event from the driving behavior data. The amount of adjustment may be based on the type of adverse event and in proportion to the number of times a given type of adverse event occurs during a trip or has occurred in the past. For example, the performance algorithm 114 may include a set value for each of different types of adverse events, and upon occurrence of an adverse event of a given type, the performance algorithm 114 may be configured to reduce the performance rating 116 by the set value for the given type. The negative adjustment responsive to an occurrence of a type of adverse event during a turn may be greater than the negative adjustment responsive to an occurrence of the type of adverse event during a non-turn.

As a further example of an adverse event, the performance algorithm 114 may include a geofenced area that the driver is not supposed to leave or, alternatively, not supposed to enter. If the driving behavior data indicates that the vehicle 102 left the geofenced area, or alternatively entered the geofenced area, during a trip, then the performance algorithm 114 may be configured to adjust the previous performance rating 116 to indicate a poorer performance for the driver or the vehicle 102. The adjustment may be in proportion to the amount of time the driver was outside the geofenced area, or alternatively, within the geofenced area. As another example, responsive to a driver traveling to a particular geographic location having poor weather or infrastructure (e.g., potholes), the performance algorithm 114 may be configured to adjust the performance rating 116 for the driver or vehicle 102 to indicate poorer performance.

Moreover, if the driving behavior data indicates that the driver maintained good performance during a set time period, which may include a set number of trips, the performance algorithm 114 may be configured to adjust the previous performance rating 116 for the driver or vehicle 102 to indicate improved performance. For example, the performance algorithm 114 may be configured such that, if a driver of the vehicle 102 avoids aggressive maneuvers and adverse events defined by the performance algorithm 114 assigned to the driver or vehicle 102 for three trips in a row, where each trip must last at least a set minimum time or distance, then performance algorithm 114 may adjust the previous performance rating 116 for the driver or vehicle 102 to indicate improved performance. The adjustment may be by a set value, and/or may be in proportion to the number of trips (or the number of trips greater than or equal to the set time period) in which the driver maintained good performance. For example, if the set time period for maintaining good performance is three trips, the performance algorithm 114 may be configured to positively adjust the performance rating 116 for the driver or vehicle 102 by a set value upon completion of each consecutive good performance trip starting with the third trip.

Alternatively or in addition to the performance algorithm 114 causing the performance evaluation unit 112 to identify the occurrence of aggressive maneuvers and/or adverse events from the driving behavior data, the component software 212 for the performance evaluation unit 112 may be configured to cause the performance evaluation unit 112 to identify the occurrence of aggressive maneuvers and/or adverse events from the driving behavior data, which may then be input to the performance algorithm 114 to compute an updated performance rating 116. In other words, the performance evaluation unit 112 may include global rules for identifying the occurrence of aggressive maneuvers and adverse events, regardless of the currently applied performance algorithm 114.

In block 316, the updated performance rating 116 may be displayed, such as via a center console display 132 of the vehicle 102. For example, the performance evaluation unit 112 may cause the infotainment system 126 to display the updated performance rating 116. In some embodiments, the performance rating 116 may be displayed as part of a summary page, which includes both the updated performance rating 116 and an identified portion of the driving behavior data that caused the performance rating 116 to change. The driver can then utilize this information to adjust his or her future driving behavior and thereby avoid actions that previously caused the performance rating 116 to indicate a poorer performance.

In some embodiments, the performance evaluation unit 112 may be configured to periodically update the performance rating 116 during a trip based on new driving behavior data collected during the trip, and thereby present the user with real time information (e.g., information presented as soon as possible after new driving behavior data affecting the performance rating 116 is collected) or near real time information that informs the driver how his or her driving is currently affecting the performance rating 116. Alternatively, the performance evaluation unit 112 may be configured to collect the driving behavior data throughout a trip, and compute and display the summary page at an end of the trip. A trip may be considered, without limitation, as the period starting from when the vehicle 102 is turned on and ending when the vehicle 102 next turns off, the period starting from when the vehicle 102 engine is turned on and ending when the vehicle 102 engine next turns off, the period starting from when the vehicle 102 is shifted into drive and ending when the vehicle 102 is next shifted into park, or the period starting when a destination is set in the vehicle 102 navigation system and ending when the vehicle 102 reaches the destination. This latter example may necessitate that a driver sets a destination before starting a drive.

In block 318, the updated performance rating 116 for the driver or vehicle 102 may be transmitted to the relevant vehicle server 104, such as the identified vehicle server 104 specific to the identifier received in block 302. Specifically, the performance evaluation unit 112 may cause the vehicle 102 to transmit the updated performance rating 116 and the identifier to the relevant vehicle server 104, which may then store the updated performance rating 116 in association with the identifier. The driving behavior data, and any maneuvers, adverse events, or other behaviors identified from the driving behavior data, may remain on the vehicle 102 and not be transmitted offboard the vehicle 102. In this way, the behaviors of each driver of the vehicle 102 may remain private.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts, sequence/lane diagrams, and/or block diagrams. In certain alternative embodiments, the functions, acts, and/or operations specified in the flowcharts, sequence/lane diagrams, and/or block diagrams may be re-ordered, processed serially, and/or processed concurrently consistent with embodiments of the invention. Moreover, any of the flowcharts, sequence/lane diagrams, and/or block diagrams may include more or fewer blocks than those illustrated consistent with embodiments of the invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a vehicle including sensors configured to generate data indicating driving behaviors while the vehicle is driven, the vehicle being configured to
download, from a server, a performance algorithm corresponding to an identifier transmitted from the vehicle to the server;
display a performance rating calculated by the vehicle by applying the data to the downloaded performance algorithm; and
communicate the performance rating and not the data to the server.

2. The system of claim 1, wherein data applied to the performance algorithm indicates a plurality of speed values, a distance traveled value, a plurality of acceleration values, and a plurality of locations of the vehicle.

3. The system of claim 1, wherein the data is generated during a trip of the vehicle, and the performance rating is calculated, displayed, and transmitted by the vehicle responsive to an ending of the trip.

4. The system of claim 1, wherein the displayed performance rating is calculated based on a previous performance rating, and the vehicle is configured to
identify a portion of the data that causes a change between the previous performance rating and the displayed performance rating; and
display the portion of the data with the displayed performance rating.

5. The system of claim 4, wherein the performance algorithm comprises a set number, and the portion indicates hard breaking and excessive acceleration each occurring a number of a times that is greater than the set number.

6. The system of claim 4, wherein the performance algorithm comprises a geofenced area, and the portion indicates leaving the geofenced area.

7. The system of claim 4, wherein the performance algorithm comprises a set duration and a set period of day, and the portion indicates continuous operation of the vehicle for longer than the set duration and operation of the vehicle during the set period of day.

8. The system of claim 1, wherein the identifier is received from a mobile device when the mobile device is within direct wireless communication range of the vehicle.

9. The system of claim 1, wherein the identifier is received via a user input on a touch screen display of the vehicle.

10. The system of claim 1, wherein the vehicle is configured to
periodically update the performance rating based on the data while the vehicle is being driven; and
display the periodically updated performance rating in real time.

11. A system comprising:
a vehicle configured to, responsive to receiving an identifier specific to a particular driver
download a first performance algorithm from a server based on the identifier;
while the vehicle is driven, generate, via vehicle sensors, data indicative of driving behaviors by the driver; and
transmit a first performance rating calculated by the vehicle by applying the data to the downloaded first performance algorithm to the server.

12. The system of claim 11, wherein the vehicle is configured to, responsive to receiving the identifier, download a second performance rating specific to the particular driver from the server based on the identifier, wherein the first performance rating is calculated by the vehicle based on the second performance rating.

13. The system of claim 11, wherein the vehicle is configured to
responsive to receiving the identifier, determine whether in-vehicle storage includes a second performance rating specific to the identifier;
responsive to determining that the in-vehicle storage does not include the second performance rating, download the second performance rating from the server; and
responsive to determining that the in-vehicle storage does include the second performance rating, retrieve the second performance rating from the in-vehicle storage,
wherein the first performance rating is calculated by the vehicle based on the second performance rating.

14. The system of claim 11, wherein the vehicle is configured to, responsive to receiving the identifier, identify the server from a plurality of available servers based on the identifier.

15. The system of claim 11, wherein a second performance algorithm for the identifier is stored in the vehicle, and the vehicle is configured to, responsive to receiving the identifier, query the server to determine whether an updated performance algorithm for the identifier is available, wherein the server is configured to, responsive to receiving the query, identify the first performance algorithm as the updated performance algorithm and transmit the first performance algorithm to the vehicle.

16. The system of claim 11, wherein the identifier is received from a mobile device responsive to the mobile device coming into direct wireless communication range of the vehicle.

17. The system of claim 11, wherein the identifier is received from a key fob responsive to a user inserting the key fob into an ignition slot of the vehicle.

18. A method comprising:
by a vehicle comprising sensors configured to generate data indicating driving behaviors while the vehicle is driven
downloading, from a server, a performance algorithm corresponding to an identifier transmitted from the vehicle to the server;
displaying a performance rating calculated by the vehicle by applying the data to the downloaded performance algorithm; and
transmitting the performance rating and not the data to the server.

19. The method of claim 18, wherein the displayed performance rating is calculated by the vehicle based on a previous performance rating, and further comprising:
identifying a portion of the data that causes a change between the previous performance rating and the displayed performance rating; and
displaying the portion of the data with the displayed performance rating.

20. The method of claim 18, further comprising:
periodically updating the performance rating based on the data while the vehicle is being driven; and
displaying the periodically updated performance rating in real time.
